(19) United States
(12) Patent Application Publication
(10) Pub. No.: US 2003/0075469 A1
(43) Pub. Date: Apr. 24, 2003

(54) Withdrawal and injection system for medical solutions and a container with said withdrawal and injection system

(76) Inventor: Reinhold Herbert, Weilrod (DE)

Correspondence Address: Marshall Gerstein & Borun, 6300 Sears Tower, 233 South Wacker Drive, Chicago, IL, 60606-6357, US

(21) Appl. No.: 10/149,354

(22) PCT Filed: Dec. 7, 2000
(86) PCT No.: PCT/EP00/12344

(51) Int. Cl. A61L 15/00

(52) U.S. Cl. 206/438

(57) ABSTRACT

The invention relates to a container, in particular, a film bag, with a withdrawal and injection system for medical solutions, which comprises a base section (2), which may be welded into the bag, with a withdrawal and an injection piece (3, 4), which are linked together by a flat bridge (35). The flat bridge is extended in the form of a bulge, between the withdrawal piece and the injection piece, which forms a closeable opening. Said opening in the container serves as a way of filing the container, by means of a filling dowel, or for transport and positioning, by mean of a fixing dowel. Furthermore a container, in particular a bag, with such a withdrawal and injection system is described.

The invention relates to a withdrawal and injection system for medical solutions, in particular for infusion solution bags, which system comprises a base part, which can be welded into the bag, with a withdrawal piece and injection piece. The invention additionally relates to a container, in particular an infusion solution bag, with such a withdrawal and injection system.

Medical solutions, in particular infusion solutions, are generally supplied in film bags. Support systems, for example injection-molded parts, hoses or the like are sealed into the film of the bag and these in turn receive the actual connection systems, e.g. connectors, septa or the like.

Withdrawal and injection systems are known which have a withdrawal piece, closed off by a membrane, and an injection piece. To withdraw the solution, the withdrawal piece is pierced by a spike to which a hose line is connected. The injection piece permits injection of a further solution using an injection syringe.

EP 0 732 114 A1 and DE 24 58 220 A1 describe withdrawal and injection systems for bags containing enteral nutrient solutions, these systems involving relatively elaborate screw-type closures.

DE 33 05 365 C2 describes a withdrawal and injection system for a film bag consisting of a base part and of a withdrawal piece and injection piece. The base part is designed in the shape of a shuttle and receives two short hose sections as withdrawal piece and injection piece which protrude outward over the base part or can end flush with the latter.

The withdrawal and injection systems designed in the shape of a shuttle have proven useful in practice. However, the disadvantage is that they are relatively expensive to produce.

An object of the invention is to make available a withdrawal and injection system for medical solutions which can be produced cost-effectively in large batch numbers and from the smallest possible number of parts, is easy to fit into the containers and is also easy to handle. A further object of the invention is to make available a container for medical solutions with such a withdrawal and injection system.

According to the invention, this object is achieved with the features of patent claims 1 and 12, respectively.

In the withdrawal and injection system according to the invention, withdrawal piece and injection piece are connected to one another by a flat bridge. The flat configuration of the base part with the integrated withdrawal piece and injection piece not only saves material but also simplifies production. The withdrawal and injection system is intended in particular for incorporation into a film bag.

Between withdrawal piece and injection piece, the flat bridge is widened in a bulged shape to form a closable opening. The opening in the bridge is used both for filling the container and for making the latter easier to handle during the production process.

A fixing dowel can be inserted into the opening for transporting the system or for holding it in the correct position and secure against twisting. By means of a filling dowel, the container can be filled via the opening. However, fixing and filling can also be effected with a common dowel which is fitted into the opening, as a result of which the handling can be made easier still.

After the container has been filled, the opening is closed simply by means of the bridge being pressed together and welded.

The system has both a withdrawal piece and an injection piece. However, a plurality of withdrawal pieces and/or injection pieces are also possible.

The base part constitutes a connector part which allows connection systems of varying configuration to be attached or inserted. Since all connection systems attach to the same base part, the machine-side parts for transport and fixing can remain unchanged, so that simple and rapid exchange is possible. The filling and closing procedure is also always the same, irrespective of the type of withdrawal and injection system.

To improve the fixing and to simplify the welding, the opening in the bridge preferably has a cross section narrowing to a point in the direction of the withdrawal piece and injection piece. Since the opening is not a circle, the dowel can be held with clamping in the opening. In addition, in the area of the bulged widening, the bridge can be pressed together particularly easily owing to this shaping and welded to give a flat connection piece.

Withdrawal piece, injection piece and bridge preferably constitute an integral component of the base part. The base part is preferably an injection-molded part of polyolefin or thermoplastic elastomer (TPE).

If the base part were to be made of a material which cannot be sealed to the film of the bag, the base part is at least partially coated with a sealable layer, in particular with a plastic layer, based on PP or PE, which can be welded to the known polyolefin films of the bags.

To prevent air bubble formation when welding base part and bag film together, the base part is preferably provided on its outer faces with ribs, to which the film is sealed.

The membrane closing off the withdrawal piece and/or injection piece is preferably arranged in the base part. It can for example consist of a plastic plate which is likewise integral with the base part.

In the injection piece, a pierceable septum is preferably arranged over the membrane, which septum permits a permanent closure even after the membrane has been pierced with an injection cannula. The membrane covering the septum can also be dispensed with, or the membrane itself can also constitute the septum.

The withdrawal piece and/or injection piece end substantially flush with the outer face of the base part. Thus, there are no outwardly protruding attachment parts present, except for tapping pieces, coverings or the like. This gives a short structural length, as a result of which the dimensions and the amount of material required for production are further reduced.

In the area of the withdrawal point and/or injection point, the base part can be given a different design, so that it is possible to optimize the geometry to the respective application. In one embodiment, the withdrawal piece and/or injection piece have a substantially hollow cylindrical section which is integral with the base part.

In a preferred embodiment designed to prevent damage to the bag film by the spike of the transfer system or by the cannula of the injection syringe for withdrawing and injecting fluid in every case, a tubular covering is provided which adjoins the base part in the area of the withdrawal piece and/or injection piece and extends inward. The covering which extends into the inside of the bag not only has a protective function, but can also serve as a guide for the spike or cannula. The covering does not need to enclose the withdrawal channel and/or injection channel on all sides. It is sufficient to protect the channel only on those sides on which there is a danger of puncturing the bag film.

In a further preferred embodiment, the covering of the withdrawal piece is a tube section which is slit in the longitudinal direction. The slit or slits in the longitudinal direction allow the bag to be completely emptied. However, instead of longitudinal slits, bores or the like can also be provided in the covering.

In a further preferred embodiment for sterile covering of the membrane and for providing a tamper-evident closure, the withdrawal piece and/or injection piece are closed with a tear-off film. Since withdrawal piece and/or injection piece preferably end substantially flush with the base part, the tear-off film can be a component part of the bag film. However, it is also possible to provide additional tear-off films or twist-off coverings.

An illustrative embodiment of the withdrawal and injection system and of a bag with the withdrawal and injection system is explained in more detail below with reference to the drawings.

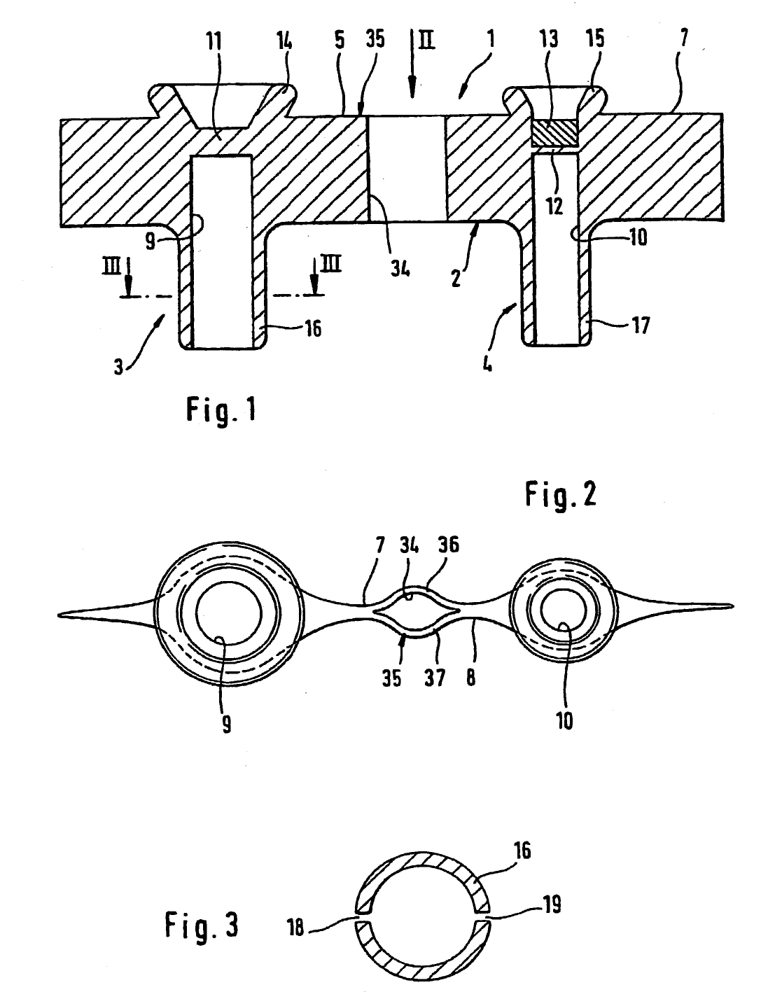

FIG. 1 an illustrative embodiment of the withdrawal and injection system in a sectional view,

FIG. 2 the withdrawal and injection system in FIG. 1 from the direction of the arrow II,

FIG. 3 a section through the withdrawal and injection system in FIG. 1 along the line III-III,

FIG. 4 a side view of the withdrawal and injection system,

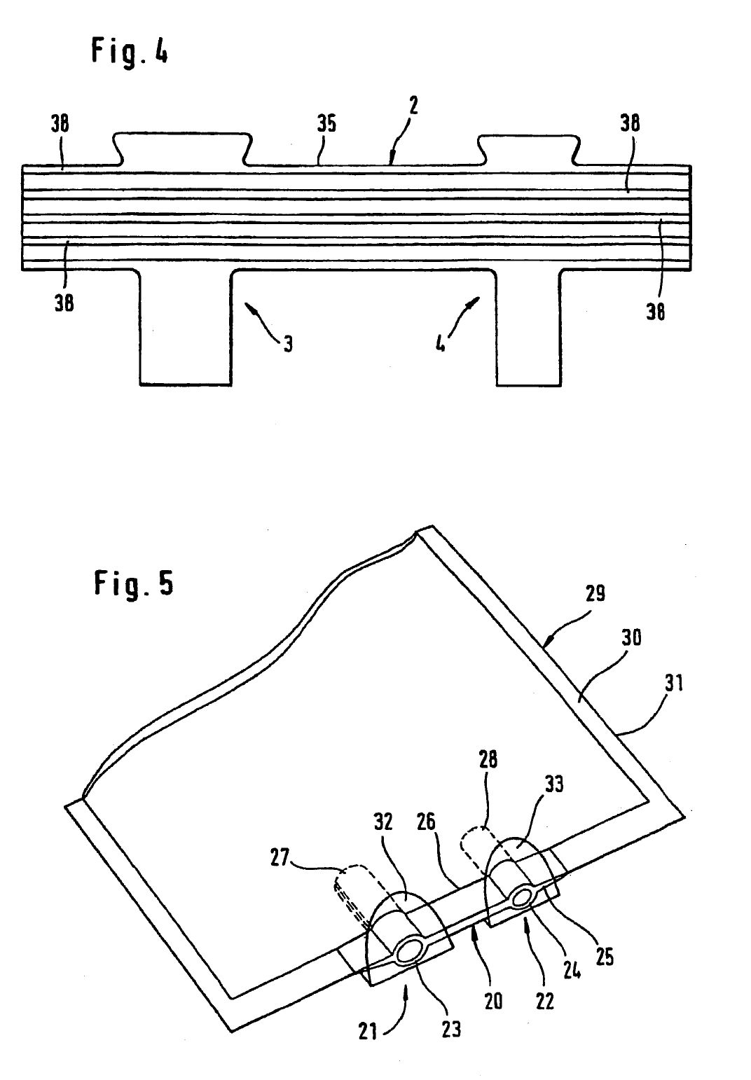

FIG. 5 a film bag with a withdrawal and injection system,

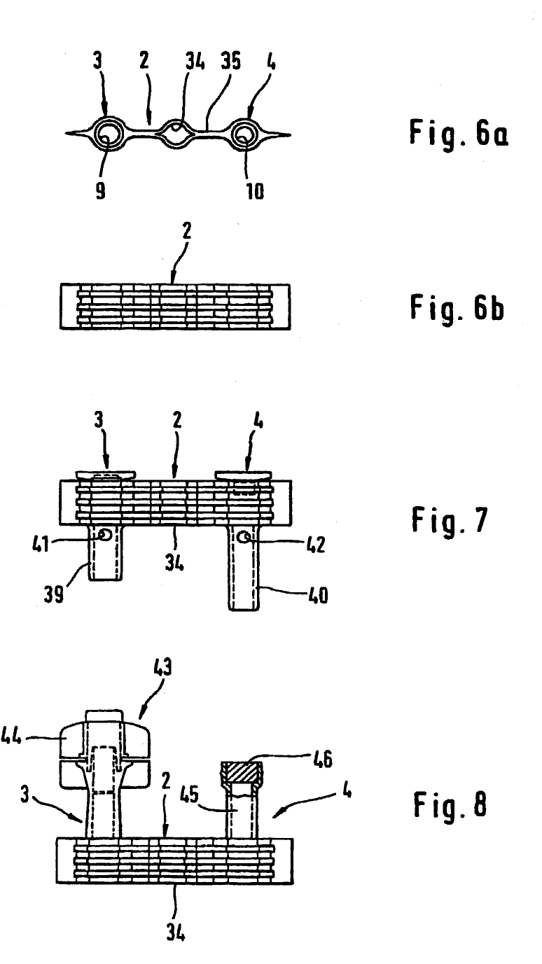

FIGS. 6a/6b the base part of two further embodiments of the withdrawal and injection system in plan view and side view,

FIG. 7 an illustrative embodiment of the withdrawal and injection system with the base part from FIGS. 6a and 6b in side view, and

FIG. 8 a side view of a further illustrative embodiment of the withdrawal and injection system with the base part from FIGS. 6a and 6b.

FIG. 1 shows a longitudinal section through the withdrawal and injection system, while said withdrawal and injection system is shown in plan view in FIG. 2.

The withdrawal and injection system 1 is a single injection-molded part, in particular made of a thermoplastic elastomer (TPE). It has a base part 2 which is designed in the shape of a shuttle and which is sealed to the film of a film bag. The base part 2 comprises a withdrawal piece 3 and an injection piece 4, which are connected to one another by a flat bridge 35.

The base part 2 welded into the bag has an outwardly directed outer face 5 and an inwardly directed inner face 6, and two long sides 7, 8 sealed to the bag film. At its ends, the base part 1 narrows to a point, and in the area of the withdrawal piece 3 and of the injection piece 4 the base part 2 has a width which corresponds to the diameter of the withdrawal piece and injection piece (FIG. 2).

The withdrawal piece and injection piece end substantially flush with the outer face 5 of the base part. They are in each case formed by a channel 9, 10 in the base part 2. The channel 9 of the withdrawal piece 3 has a diameter which corresponds to that of the spike (not shown) of the transfer hose for withdrawing the fluid, while the diameter of the channel 10 of the injection piece 4 is smaller. The channels 9, 10 are closed in a sterile manner by a pierceable plastic membrane 11, 12 which is integral with the base part 2. To permanently close off the injection piece, a pierceable septum 13 is also inserted into the channel 10 above the membrane 12. On its outer face 5, the base part 2 has an annular shoulder 14 which surrounds the opening of the channel 9, and an annular shoulder 15 which surrounds the opening of the channel 10. The annular shoulders 14, 15 provide for better guiding of the spike and injection cannula, respectively.

On the inner face 6 of the base part 2, a tube section 16 adjoins the channel 9 of the withdrawal piece 3 and a tube section 17 adjoins the channel 10 of the injection piece 4. At least the tube section 16 of the withdrawal piece has two slits 18, 19 which lie in the plane of the base part 2 (FIG. 3). When the membrane 11 of the withdrawal piece 3 is pierced by the spike, the tube section 16 serves, on the one hand, as a guide for the spike and, on the other hand, as a covering which prevents puncture of the film bag. The bag can be completely emptied via the lateral slits 18, 19 in the tube section 16 of the withdrawal piece. The tube section 17 of the injection piece 4 also serves in particular to protect the bag film.

Between withdrawal piece 3 and injection piece 4, the flat bridge 35 is widened in a bulged shape to form an opening 34. The opening 34 has a cross section which narrows to a point in the direction of the withdrawal piece and injection piece, so that the two side edges 36, 37 of the bridge can be easily pressed together in the area of the opening.

The opening 34 serves on the one hand for filling and on the other hand for fixing the bag. To fix the bag, a fixing dowel is introduced into the opening, which is not circular but instead narrows to a point at the ends, and the fixing dowel is clamped between the side edges 36, 37. In this way, the bag can be transported in the correct position and in a manner secure against twisting.

The bag is filled via a filling dowel which is likewise introduced into the opening 35. To close the opening, the two outer walls 36, 37 which have a high degree of flexibility are pressed firmly together and welded to one another. The base part can be fixed with the same dowel as is used to fill the bag.

At both outer faces, the base part 2 has a plurality of transverse bridges 38 which are sealed to the bag film. FIG. 4 shows a side view of the base part with the bridges.

FIG. 5 shows a film bag with a withdrawal and injection system which is welded into a film bag. The base part 20 is designed as a flat bridge which narrows to a point at its ends, while the withdrawal piece 21 and the injection piece 22 each have a hollow cylindrical section 23, 24 of different diameter which is integral with the base part. The hollow cylindrical sections 23, 24 end flush with the outer face 25 of the base part. On the inner face 26 of the base part 20, the hollow cylindrical sections 23, 24 merge into tubular coverings 27, 28, of which at least the covering of the withdrawal piece has longitudinal slits in its sides. These are represented only as broken lines in FIG. 4.

The filling and fixing opening 34 has been closed by means of the bridge which connects the withdrawal piece and injection piece being pressed together in the area of the bulge-shaped widening and by the two outer walls being welded together so that the bridge is made flat along its entire length between withdrawal piece and injection piece.

The film bag 29 which can be filled with an infusion solution consists of two plastic films 30, 31 which are superposed, welded to one another at their edges and sealed to the long sides of the base part 20. On its upper edge, the lower bag film 31 has protruding tabs 32, 33 which extend over the openings of the withdrawal piece 21 and injection piece 22 and are sealed to the outer face 25 of the base part. To withdraw or inject fluids, the tabs 32, 33 are torn off so that the filling or withdrawal opening is exposed.

If the withdrawal and injection system is made of a material which cannot be sealed to the bag film, at least the base part is coated on its long sides with a layer, in particular a plastic layer based on PP, with which the bag film, for example a polyolefin film, can be sealed.

FIGS. 7 and 8 show side views of two further illustrative embodiments of the withdrawal and injection system in accordance with the base part in FIGS. 6a and 6b. The base part differs from the base part in the illustrative embodiment of the withdrawal and injection system described with reference to FIGS. 1 to 4 principally in terms of the dimensioning of the withdrawal opening 9 and injection opening 10, which have the same diameters. The parts corresponding to one another are provided with the same reference numbers.

The illustrative embodiment according to FIG. 7 has two attachment parts which lie on the inner face of the base part 2 lying on the container. The withdrawal piece 3 and injection piece 4 merge into tube sections 39, 40, respectively, which are of different length. Both tube sections 39, 40 are provided with lateral openings 41, 42, respectively, so as to be able to empty the container completely.

The illustrative embodiment in FIG. 8 differs from the embodiment in FIG. 7 in that the attachment parts lie on the outer face of the base part 2 directed away from the container. The withdrawal piece 3 merges into a connection section 43 which is closed with a tear-off part 44. A short tube section 45 closed off by a septum 46 adjoins the injection piece 4.

1. A withdrawal and injection system for medical solutions, in particular containers containing infusion solutions, with a base part (2) which can be fitted into the container and which comprises a withdrawal piece and injection piece (3, 4; 21, 22), characterized in that the withdrawal piece and injection piece (3, 4; 21, 22) are connected to one another by a flat bridge (35) which is widened in a bulged shape between withdrawal piece and injection piece so as to form a closable opening (34).

2. The withdrawal and injection system as claimed in claim 1, characterized in that the opening (34) in the bridge (35) has a cross section narrowing to a point in the direction of the withdrawal piece and injection piece (3, 4; 21, 22).

3. The withdrawal and injection system as claimed in claim 1 or 2, characterized in that withdrawal piece, injection piece and bridge (3, 4, 35) are an integral component of the base part (2).

4. The withdrawal and injection system as claimed in claim 3, characterized in that the base part (2) is an injection-molded part of polyolefin or thermoplastic elastomer.

5. The withdrawal and injection system as claimed in claim 3 or 4, characterized in that the base part (2) is coated at least partially with a sealable layer.

6. The withdrawal and injection system as claimed in one of claims 3 through 5, characterized in that the base part (2) is provided with ribs (38) on the outer faces.

7. The withdrawal and injection system as claimed in one of claims 1 through 6, characterized in that a membrane (12) is provided which closes off the withdrawal piece and/or injection piece (3, 4).

8. The withdrawal and injection system as claimed in claim 7, characterized in that a pierceable septum (13) is arranged over the membrane (12) of the injection piece (4).

9. The withdrawal and injection system as claimed in one of claims 1 through 8, characterized in that the injection piece and/or withdrawal piece (3, 4) merges into a tubular covering (16, 17) on its inner face (6) directed toward the container.

10. The withdrawal and injection system as claimed in claim 9, characterized in that the tubular covering of the withdrawal piece and/or injection piece (3, 4) is a tube section (16, 17) slit in the longitudinal direction.

11. The withdrawal and injection system as claimed in one of claims 1 through 8, characterized in that the withdrawal piece and injection piece (3, 4) end flush with the outer face of the base part directed away from the container.

12. The withdrawal and injection system as claimed in one of claims 1 through 9, characterized in that the withdrawal piece and/or injection piece (21, 22) are closed with a tear-off film (33, 34).

13. A container for medical solutions, in particular infusion solutions, with the withdrawal and injection system as claimed in one of claims 1 through 12, characterized in that the withdrawal and injection system (1, 20) is fitted into the container in such a way that the withdrawal and injection system ends substantially flush with the container.
